(19) United States
(12) Patent Application Publication
(10) Pub. No.: US 2026/0016934 A1
(43) Pub. Date: Jan. 15, 2026

(54) USER CONTENT CONDITIONING IN GRAPHIC DESIGN LAYOUT GENERATION

(71) Applicant: Adobe Inc., San Jose, CA (US)

(72) Inventors: Swasti Shreya Mishra, Amsterdam (NL); Tripti Shukla, Lucknow (IN); Srikrishna Karanam, Bangalore (IN); Balaji Vasan Srinivasan, Bangalore (IN)

(21) Appl. No.: 18/771,794

(22) Filed: Jul. 12, 2024

(51) Int. Cl. G06F 3/0484

(52) U.S. Cl. CPC G06F 3/0484

(57) ABSTRACT

The present disclosure relates to systems, non-transitory computer-readable media, and methods for generating graphic design layouts using a machine learning model to modify a layout according to content conditions. For example, the disclosed systems receive, from a client device, one or more content conditions defining parameters for generating design layouts. In some embodiments, the disclosed systems generate a set of fused features from the one or more content conditions. In certain embodiments, the disclosed systems encode, utilizing a machine learning, a content-conditioned layout embedding from the set of fused features. In some embodiments, the disclosed systems generate, from the content-conditioned layout embedding utilizing the machine learning model, a design layout comprising layout parameters defined by the one or more content conditions.

### BACKGROUND

Graphic designs communicate information in a precise yet appealing manner. Because graphic designs often consist of multimodal components (e.g. images and text), the layout of graphic designs is vital for directing attention and enhancing visual appeal. Over time, developers have created technologies to improve graphic design platforms for generating and editing multimodal designs that depict text and images together. As part of current graphic design tools, some conventional systems enable selecting and editing content from a wide array of pre-generated design templates. Despite these advances, however, many conventional systems exhibit a number of deficiencies or drawbacks, particularly in understanding design components such as semantic aspects of design content and/or accurately generating design layouts based on such design components.

### SUMMARY

Embodiments of the present disclosure provide benefits and/or solve one or more of the foregoing or other problems in the art with systems, non-transitory computer-readable media, and methods for generating graphic design layouts using a content-conditioned variational generative model to define a layout according to content conditions. For example, the disclosed systems generate graphic design layouts informed by multimodal data provided by a client device and/or otherwise determined. In some embodiments, the disclosed systems generate multiple variants of a graphic design layout according to content conditions that define multimodal parameters for defining visual components of the layout. In one or more embodiments, the disclosed systems generate the conditioned design layouts by training and using a content-conditioned variational generative model that includes a variational autoencoder and a specialized conditioning function. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a layout generation system operates in accordance with one or more embodiments.

FIG. 2 illustrates an example overview of generating a content-conditioned design layout using a content-conditioned variational generative model in accordance with one or more embodiments.

FIG. 3 illustrates an example diagram of training a content-conditioned variational generative model in accordance with one or more embodiments.

FIG. 4 illustrates an example diagram of implementing or utilizing a content-conditioned variational generative model to generate a design layout in accordance with one or more embodiments.

FIG. 5 illustrates an example table comparing qualitative results of the layout generation system against a prior system in accordance with one or more embodiments.

FIG. 6 illustrates an example table comparing qualitative results of the layout generation system against a prior system in accordance with one or more embodiments.

FIG. 7 illustrates an example table comparing results of the layout generation system with prior systems in accordance with one or more embodiments.

FIG. 8 illustrates a schematic diagram of a layout generation system in accordance with one or more embodiments.

FIG. 9 illustrates an example series of acts for generating a design layout using content-conditions in accordance with one or more embodiments.

FIG. 10 illustrates an example series of acts for training a content-conditioned variational generative model using a training dataset in accordance with one or more embodiments.

FIG. 11 illustrates an example series of acts for training and/or implementing a content-conditioned variational generative model to generate a design layout in accordance with one or more embodiments.

FIG. 12 illustrates a block diagram of an example computing device for implementing one or more embodiments of the present disclosure.

### DETAILED DESCRIPTION

This disclosure describes one or more embodiments of a layout generation system that generates graphic design layouts using a content-conditioned variational generative model to define a layout according to content conditions. For example, the layout generation system receives or identifies content condition that define multimodal parameters for a design layout, indicating how much, where, and/or what types of content (e.g., text or images) to place within a generated layout. In some embodiments, the layout generation system further uses a content conditioning function (of the content-conditioned variational generative model) to apply the content conditions to a design layout, thus modifying size, location, and amount of text and image content. In certain cases, the layout generation system further uses the content-conditioned variational generative model to generate a content-conditioned design layout that depicts multimodal content according to the content conditions.

As just mentioned, in some embodiments, the layout generation system generates content-conditioned design layouts. To do so, the layout generation system receives or identifies content conditions to use as the basis for conditioning the graphic design layout in the end. For example, the layout generation system receives content conditions that define semantic aspects and other multimodal parameters defining how and/or where to place text and images in a design layout. Such content conditions include images, keywords, categories, text ratios, and/or image ratios. In some embodiments, the layout generation system fuses the content conditions into a set of fused features interpretable by a content-conditioned variational generative model to generate the conditioned layout.

In one or more embodiments, the layout generation system utilizes a content-conditioned variational generative model to generate a content-conditioned design layout. For instance, the layout generation system uses a conditioning function as part of the content-conditioned variational generative model to condition or modify a baseline or initial design layout. In some cases, the layout generation system uses a variational autoencoder of the content-conditioned variational generative model to generate the initial/baseline design layout (or a layout embedding representing an initial layout) and/or to generate a layout distribution (e.g., a latent space defining a distribution of design layouts). Additionally, in some embodiments, the layout generation system uses the conditioning function to condition the layout or the layout distribution using the content conditions, thus generating a content-conditioned layout distribution (e.g., a modified or conditioned latent space). For example, the layout generation system uses the conditioning function to generate a content-conditioned layout embedding in the modified latent space by conditioning the initial layout embedding using the set of fused features.

Additionally, in some embodiments, the layout generation system uses (a decoder of) the content-conditioned variational generative model to decode the content-conditioned layout embedding. For instance, the layout generation system uses the content-conditioned variational generative model to generate a content-conditioned layout embedding by decoding the content-conditioned layout embedding. Thus, in one or more embodiments, the layout generation system generates a design layout that is conditioned on the set of fused features to depict content according to semantic parameters and/or other multimodal parameters defined by the image, keywords, categories, text ratios, and/or image ratios indicated by the content conditions.

In one or more embodiments, the layout generation system also trains the content-conditioned variational generative model to perform the above processes and operations. For example, the layout generation system receives a training dataset that includes a sample design layout along with sample content conditions. In some cases, the layout generation system uses the training dataset to train a variational autoencoder of the content-conditioned variational generative model using a reconstruction loss to compare a reconstructed design layout with the sample design layout and/or a divergence loss to compare a layout embedding distribution of the variational autoencoder with a prior layout distribution. In some embodiments, the layout generation system further learns the content conditioning function and trains a decoder of the content-conditioned variational generative model using another reconstruction loss to compare a content-conditioned reconstructed design layout with the initial design layout and using a maximum mean discrepancy loss to compare the content-conditioned layout distribution with a prior layout distribution.

As suggested above, many conventional systems exhibit a number of shortcomings or disadvantages, particularly in their understanding of text-rich image content. To elaborate, many existing systems generate inaccurate graphic design layouts. For example, existing systems generate design templates using fixed layouts that do not adapt to semantic considerations or other multimodal layout parameters for dictating content placement and sizing. Indeed, the design layouts of existing systems generally reflect no understanding of semantics or other multimodal parameters and thus generate layouts that cannot accurately reflect such multimodal parameters.

Contributing to their inaccuracies, some prior systems fail to provide controllable content conditioning for design layouts. To elaborate, because existing system lack the capability to understand multimodal parameters for conditioning layouts, these existing systems cannot provide tools for controlling the content conditioning of the layouts. Indeed, even existing systems that provide search tools for identifying matching design templates provide no indication or function for layout modification based on semantic content or other content conditions.

Due at least in part to their inaccuracies, many prior systems are also inefficient. More specifically, existing systems often require excessive numbers of client device interactions to modify and augment designs from templates to arrange content according to a desired layout. Indeed, in many cases, the editing tools of existing systems extend only to moving and modifying depicted content, such as text and images, to place the content in selected locations with indicated sizes. But the existing tools provide no mechanism for generating a new design layout with text and images depicted with locations and sizing dictated by device-defined content conditions at the outset.

As suggested above, embodiments of the layout generation system provide certain improvements or advantages over conventional systems. For example, embodiments of the layout generation system improve accuracy in generating graphic design layouts based on content conditions. More particularly, the layout generation system generates design layouts that accurately depict content reflecting semantic considerations and multimodal parameters defined by content conditions. Compared to prior systems that are incapable understanding content conditions as part of generating design layouts, the layout generation system much more accurately generates layouts depicting text and images in locations and sizes dictated by content conditions (as set via a client device).

As part of improving the accuracy of design layout generation, in some embodiments, the layout generation system trains and uses a content-conditioned variational generative model. For instance, the layout generation system trains the content-conditioned variational generative model using training data that includes sample design layouts and example content conditions. Using the training data, the layout generation system trains components of the content-conditioned variational generative model, including a variational autoencoder, a conditioning function, and a conditional decoder. Thus, the layout generation system utilizes a trained version of the content-conditioned variational generative model to generate design layouts that accurately reflect content conditions by placing multimodal content (e.g., text and images) having indicated locations and sizes.

Due at least in part to its improved accuracy, certain embodiments of the layout generation system also improve efficiency relative to prior systems. While many prior systems require excessive numbers of device interactions to reposition, resize, or otherwise modify design components of available templates on a component-by-component basis, the layout generation system generates conditioned layouts from the ground up. By using a content-conditioned variational generative model to generate content-conditioned layouts, the layout generation system greatly reduces the number of device interactions through eliminating (or significantly reducing) the need to reposition, resize, or otherwise modify components of a design. The layout generation system thus improves efficiency by reducing interactions for accessing desired data and/or functionality through a more accurate layout generation process that generates conditioned layouts reflecting content as dictated by content conditions.

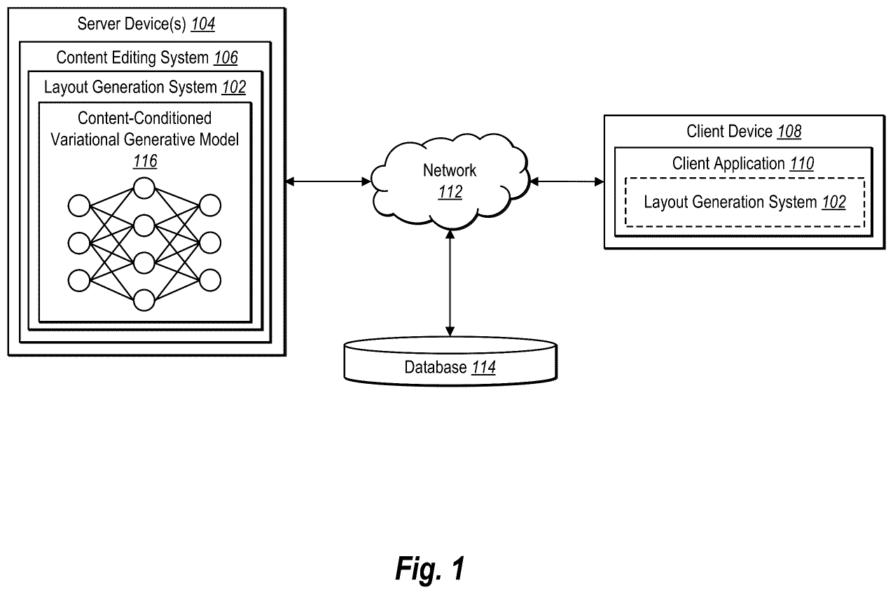

Additional detail regarding the layout generation system will now be provided with reference to the figures. For example, FIG. 1 illustrates a schematic diagram of an example system environment for implementing a layout generation system 102 in accordance with one or more embodiments. An overview of the layout generation system 102 is described in relation to FIG. 1. Thereafter, a more detailed description of the components and processes of the layout generation system 102 is provided in relation to the subsequent figures.

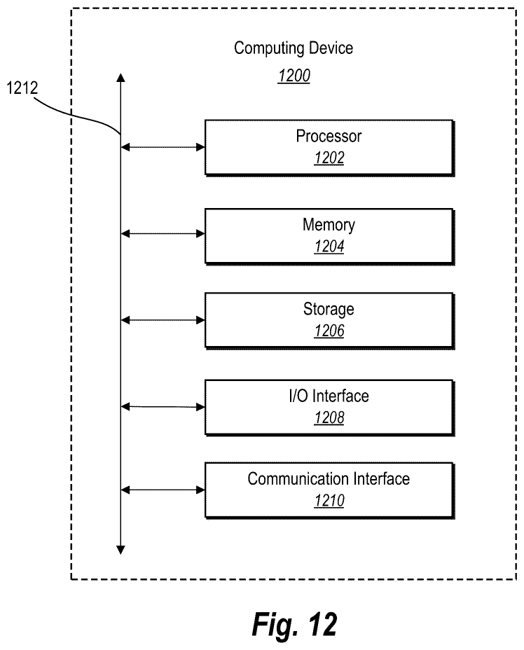

As shown, the environment includes server(s) 104, a client device 108, a database 114, and a network 112. Each of the components of the environment communicate via the network 112, and the network 112 is any suitable network over which computing devices communicate. Example networks are discussed in more detail below in relation to FIG. 12.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 12. Although FIG. 1 illustrates a single instance of the client device 108, in some embodiments, the environment includes multiple different client devices, each associated with a different user. The client device 108 communicates with the server(s) 104 and/or the content editing system 106 via network 112. For example, the client device 108 receives inputs defining content conditions, such as digital images, keywords, categories, text ratios, and/or image ratios and provides information to server(s) 104 indicating content conditions for generating design layouts.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server(s) 104. The client application 110 presents or displays information to a user, including a user interface for using a content-conditioned variational generative model 116 to generate content-conditioned design layouts from content conditions provided via the client device 108.

As also illustrated in FIG. 1, the environment includes the server(s) 104. The server(s) 104 generates, tracks, stores, processes, receives, and transmits electronic data, such as content conditions, generated design layouts, layout distributions, and/or layout embeddings. For example, the server(s) 104 receives data from the client device 108 in the form of one or more content conditions. In response, the server(s) 104 provides data to the client device 108 in the form of a trained model (e.g., the content-conditioned variational generative model 116) or a design layout generated by the content-conditioned variational generative model 116 that is trained as described herein. For example, the server(s) 104 communicate with the database 114 to generate one or more training datasets of sample design layouts and sample content conditions for training the content-conditioned variational generative model 116.

In some embodiments, the server(s) 104 communicates with the client device 108 to transmit and/or receive data via the network 112. In some embodiments, the server(s) 104 comprises a distributed server where the server(s) 104 includes a number of server devices distributed across the network 112 and located in different physical locations. The server(s) 104 comprise a content server, an application server, a communication server, a web-hosting server, a multidimensional server, or a machine learning server.

As further shown in FIG. 1, the server(s) 104 also includes the layout generation system 102 as part of a content editing system 106. For example, in one or more implementations, the content editing system 106 stores, generates, modifies, edits, enhances, provides, distributes, and/or shares digital content, such as digital images and generated design layouts. For example, the content editing system 106 provides digital content for editing and/or facilitates other forms of digital processing. In some implementations, the content editing system 106 provides digital content to particular digital profiles associated with client devices (e.g., the client device 108).

In one or more embodiments, the server(s) 104 includes all, or a portion of, the layout generation system 102. For example, the layout generation system 102 operates on the server(s) 104 to generate or modify one or more datasets, such as a training dataset for the content-conditioned variational generative model 116. In some embodiments, the client device 108 includes all or part of the layout generation system 102. For example, the client device 108 generates, obtains (e.g., downloads), or uses one or more aspects of the layout generation system 102, such as the content-conditioned variational generative model 116. Indeed, in some implementations, as illustrated in FIG. 1, the layout generation system 102 is located in whole or in part of the client device 108 (e.g., as part of the client application 110). For example, the layout generation system 102 includes a web hosting application that allows the client device 108 to interact with the server(s) 104. To illustrate, in one or more implementations, the client device 108 accesses a web page supported and/or hosted by the server(s) 104.

In one or more embodiments, the client device 108 and the server(s) 104 work together to implement the layout generation system 102. For example, in some embodiments, the server(s) 104 train one or more neural networks (e.g., the content-conditioned variational generative model 116) and provide the one or more neural networks to the client device 108 for implementation. In some embodiments, the server(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the layout generation system 102 is implemented by (e.g., located entirely or in part on) the client device 108. As another example, the content-conditioned variational generative model 116 is stored within the database 114. In addition, in one or more embodiments, the client device 108 communicates directly with the layout generation system 102, bypassing the network 112.

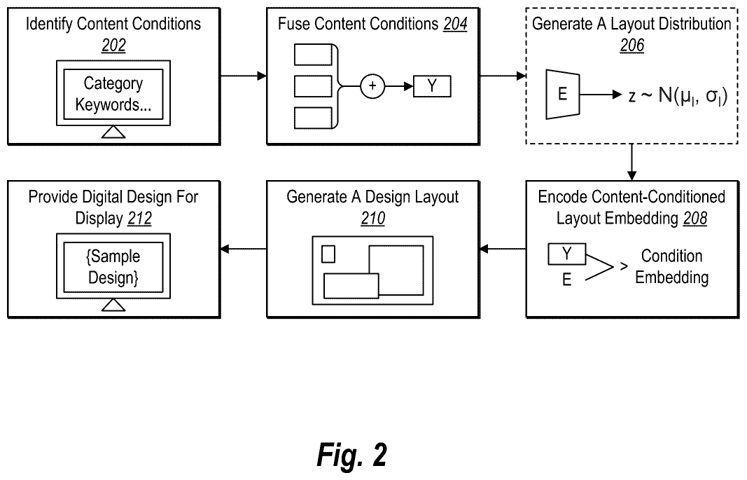

As mentioned, in one or more embodiments, the layout generation system 102 generates a content-conditioned design layout using a content-conditioned variational generative model. In particular, the layout generation system 102 trains and utilizes a content-conditioned variational generative model to generate graphic design layouts depicting content according to content conditions. FIG. 2 illustrates an example overview of generating a content-conditioned design layout using a content-conditioned variational generative model in accordance with one or more embodiments. Additional detail regarding the acts of FIG. 2 is provided thereafter with reference to subsequent figures.

As illustrated in FIG. 2, the layout generation system 102 performs an act 202 to identify content conditions. To elaborate, the layout generation system 102 identifies or receives content conditions from a client device (e.g., the client device 108). For example, the layout generation system 102 receives input from a client device to define content conditions, such as images, keywords, categories, text ratios, and/or image ratios. In some embodiments, a content condition includes or refers to computer data defining one or more visual parameters of a graphics design layout. In certain cases, a content condition is defined and/or provided by user interaction with a client device. Relatedly, keywords include or refer to text words or phrases extracted from user-defined text input defining semantic concepts or topics for including in a design layout. In addition, a text ratio includes or refers to a ratio or a proportion of text space to overall layout canvas space in a design layout. Further, an image ratio includes or refers to a ratio or a proportion of text space to overall canvas space in a design layout.

As also illustrated in FIG. 2, the layout generation system 102 performs an act 204 to fuse content conditions. The layout generation system 102 fuses content conditions by extracting content condition embeddings from content conditions and combining the content condition embeddings into a fused embedding. Indeed, the layout generation system 102 generates a set of fused features by fusing or combining (e.g., concatenating) the content condition embeddings for downstream use. In some embodiments, a set of fused features includes or refers to a fusion or a combination of content condition embeddings. Relatedly, in some cases, a content condition embedding includes or refers to a latent vector representation of a content condition within an embedding space or a latent space.

As further illustrated in FIG. 2, in some embodiments the layout generation system 102 performs an act 206 to generate a layout distribution (or a layout embedding distribution). To elaborate, the layout generation system 102 uses a content-conditioned variational generative model (e.g., the content-conditioned variational generative model 116) to generate a distribution for design layouts in a latent space. For example, the layout generation system 102 uses a variational autoencoder as part of the content-conditioned variational generative model to extract layout embeddings from one or more design layouts to thus form the layout distribution. In some embodiments, a content-conditioned variational generative model refers to a neural network that generates a content-conditioned design layout from content conditioned and one or more design layouts (or design layout embeddings represented by a layout distribution). For instance, a content-conditioned variational generative model is made up of components including a variational autoencoder (which itself includes an encoder neural network and a decoder neural network), a conditioning function, and a conditional decoder.

In one or more embodiments, a neural network (e.g., a content-conditioned variational generative model) includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., digital images and/or digital text) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network, a variational autoencoder, or a diffusion neural network).

Relatedly, in some cases, a variational autoencoder includes or refers to a neural network, such as a generative neural network, that combines techniques from deep learning and Bayesian inference. For example, a variational autoencoder is an extension of the traditional autoencoder architecture and is used to learn complex data distributions using an encoder and a decoder. The encoder maps input data to a latent space by producing a probability distribution (e.g., a layout distribution) over latent variables. The decoder maps samples latent variables back to input space to learn a conditional distribution for reconstructing the input data.

As noted, the layout generation system 102 generates a layout distribution (from one or more input layouts) using the variational autoencoder of the content-conditioned variational generative model. The layout generation system 102 further utilizes the layout distribution to inform the process of generating content-conditioned design layouts. For instance, as illustrated in FIG. 2, the layout generation system 102 performs an act 208 to encode a content-conditioned layout embedding. Particularly, the layout generation system 102 uses the layout distribution as a basis for conditioning with fused features generated from content conditions. In some cases, the layout generation system 102 modifies, augments, or conditions the layout distribution of the variational autoencoder with the embedding of the fused features to generate a content-conditioned layout embedding distribution in a modified (e.g., content-conditioned) latent space. For instance, the layout generation system 102 uses a conditioning function to condition the layout embedding and/or the layout distribution to generate the content-conditioned layout embedding and/or the content-conditioned layout embedding distribution in the modified latent space.

As further illustrated in FIG. 2, the layout generation system 102 performs an act 210 to generate a design layout. More specifically, the layout generation system 102 generates a design layout using a conditional decoder of the content-conditioned variational generative model to decode a content-conditioned layout embedding. Indeed, the decoder processes embeddings in the conditioned layout space that made up of the content-conditioned layout embeddings to reconstruct design layouts. In some cases, the layout generation system 102 generates multiple content-conditioned design layouts from multiple embeddings in the content-conditioned layout distribution. For instance, the conditional decoder decodes the latent distribution back to the input space to generate one or more design layouts conditioned on the fused features, where the layouts thus depict multimodal content of text and images having locations and sizes indicated by the content conditions.

As shown in FIG. 2, the layout generation system 102 further performs an act 212 to provide a digital design for display. To elaborate, the layout generation system 102 generates a graphical digital design from a content-conditioned design layout. The layout generation system 102 generates the digital design by generating and placing text and image content in areas of a design canvas indicated by the content-conditioned design layout. In addition, the layout generation system 102 provides the digital design for display on a client device (e.g., the client device 108 which provided the content conditions).

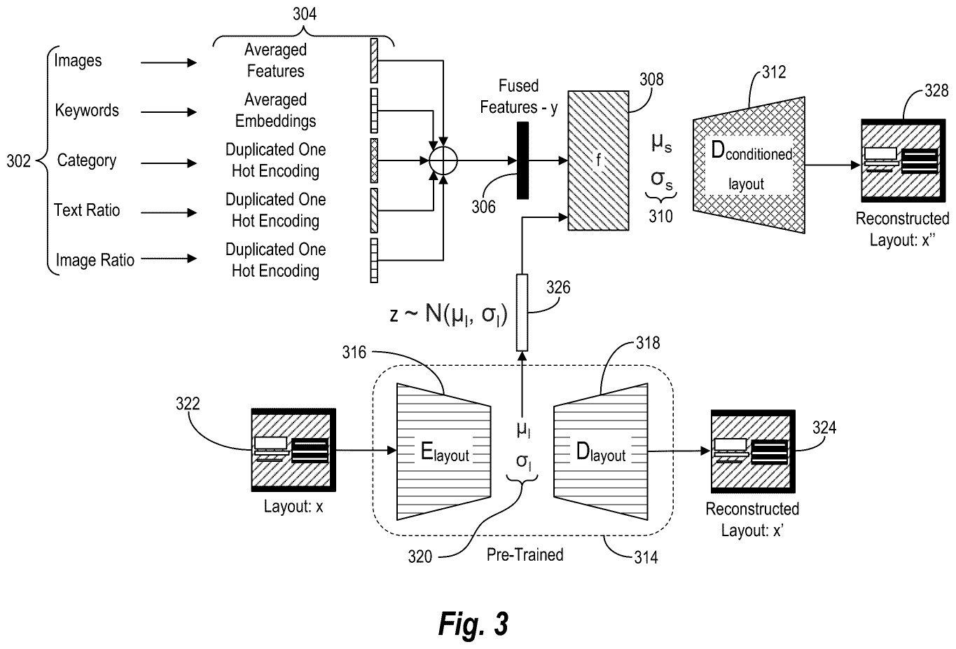

As mentioned above, in certain described embodiments, the layout generation system 102 trains a content-conditioned variational generative model to generate design layouts. In particular, the layout generation system 102 trains a content-conditioned variational generative model that includes a variational autoencoder, a conditioning function, and a conditional decoder using a training database. FIG. 3 illustrates an example diagram of training a content-conditioned variational generative model in accordance with one or more embodiments.

As illustrated in FIG. 3, the layout generation system 102 accesses content conditions 302. In particular, the layout generation system 102 accesses a training database that stores the content conditions 302 along with a sample design layout 322. In addition, the layout generation system 102 uses the training data in the training database to train the various components of the content-conditioned variational generative model, which include the variational autoencoder 314, the conditioning function 308, and the conditional decoder 312. In some embodiments, the layout generation system 102 uses a two-step training process, including a first step that involves training the variational autoencoder 314 for layout reconstruction and a second step that involves training the content-conditioned variational generative model for disentangling a feature space.

Regarding the first step of the training process, the layout generation system 102 accesses a sample design layout 322 (x) from a training database. The layout generation system 102 inputs the sample design layout 322 into a variational autoencoder 314 that includes an encoder 316 (E_{layout}) and a decoder 318 (D_{layout}). In some embodiments, variational autoencoder 314 processes the sample design layout 322 using the encoder 316 to extract a sample layout embedding. Indeed, the encoder 316 generates a layout embedding within a sample layout distribution 320 in a latent space. Specifically, the encoder 316 induces a layout distribution 320 (p(\hat{z}|x)) to map the sample design layout 322 from the input space or the real layout distribution p(x) to the latent space.

Concurrently, the decoder 318 of the variational autoencoder 314 induces a distribution q(x′|z) to map samples from a prior distribution q(z) to the layout space. In some cases, the prior distribution q(z) is a standard normal distribution. Indeed, the decoder 318 processes or decodes a layout embedding extracted from the sample design layout 322 and embedded in the layout distribution 320 to generate a reconstructed design layout 324.

As part of the training process, the layout generation system 102 modifies parameters of variational autoencoder 314 (e.g., of the encoder 316 and/or the decoder 318) to reduce one or more measures of loss and improve accuracy in reconstructing sample design layouts. The layout generation system 102 performs multiple training iterations or epochs, inputting new sample design layouts from the training database each time to generate reconstructed versions, compare the reconstructions with initial sample inputs, and adjust model parameters to reduce loss. Through the training process, the layout generation system 102 adjusts parameters aiming to match the two joint distributions p(x, \hat{z})=p(\hat{z}|x)p(x) and q(x′, z)=q(x═|z)q(z).

To elaborate, the layout generation system 102 trains the encoder 316 and the decoder 318 end-to-end using a variational autoencoder training objective by reducing or minimizing a reconstruction loss L_{rec} between ground truth design layouts (e.g., the sample design layout 322), represented by x. Indeed, the layout generation system 102 uses a reconstruction loss to compare the reconstructed design layout 324 with the sample design layout 322 (and does the same for other reconstructions on other iterations). In some cases, the layout generation system 102 uses a reconstruction loss as given by:

$${L}_{rec} = {‖ x - {D}_{layout} ( {E}_{layout} ( x ) ) ‖}^{2}$$

where E_{layout}(x) represents the encoded layout embedding of a sample design layout x (e.g., the sample design layout 322) and D_{layout}(E_{layout}(x)) represents the decoded version of the same—e.g., the reconstructed design layout 324.

In addition, the layout generation system 102 utilizes a Kullback-Leibler (KL) divergence loss L_{KL} to compare distributions. Specifically, the layout generation system 102 uses a divergence loss to compare a layout embedding distribution (e.g., the layout distribution 320) with a prior layout distribution. In some embodiments, the layout generation system 102 uses a KL divergence loss as given by:

$${L}_{KL} = {D}_{Layout} ( p ( \hat{z} \vert x ) \text{\vert \vert} q ( z ) ) = {D}_{Layout} ( N ( {μ}_{i} , {σ}_{i} ) \text{\vert \vert} N ( 0 , 1 ) )$$

where p(\hat{z}|x) is a layout embedding distribution (e.g., the layout distribution 320) and q(z) is a prior distribution (e.g., a standard normal distribution). In some cases, N(μᵢ, σᵢ) represents the learned distribution p(\hat{z}|x) (e.g., a layout embedding distribution, such as the layout distribution 320) for downstream use in the conditioning function 308 of the content-conditioned variational generative model.

As noted, in addition to training the variational autoencoder 314, the layout generation system 102 trains other components of the content-conditioned variational generative model. For example, the layout generation system 102 uses the learned distribution N(μᵢ, σᵢ) to learn a conditioning function 308 (f). As part of the training process, the layout generation system 102 accesses content conditions 302 from a training database.

In addition, the layout generation system 102 uses the content-conditioned variational generative model and/or other models to extract or encode content condition embeddings 304 from the content conditions 302. For instance, the layout generation system 102 extracts ResNet features from images, Word2Vec embeddings from keywords, and one hot encodings for categories, text ratios, and image ratios. The layout generation system 102 further combines (e.g., averages) the image features and/or the keyword embeddings. In some cases, the layout generation system 102 generates and duplicates (e.g., for matching embedding lengths or sizes) one hot encodings for categories, text ratios, and image ratios.

As further illustrated in FIG. 3, the layout generation system 102 generates a set of fused features 306 (y). In particular, the layout generation system 102 fuses the content condition embeddings 304 by concatenating or otherwise combining the embeddings in a single, unified representation. Accordingly, the layout generation system 102 generates the set of fused features 306 that represent a combined encoding of multimodal inputs defining parameters for placing, sizing, and otherwise depicting content in a design layout.

Additionally, the layout generation system 102 uses the set of fused features 306 to generate a reconstructed content-conditioned design layout 328. To elaborate, the layout generation system 102 learns a conditioning function 308 that combines the set of fused features 306 and the learned distribution (e.g., the layout distribution 320) to generate a content-conditioned latent space N(μₛ, σₛ). Indeed, the conditioning function 308 projects the latent space N(μᵢ, σᵢ) or the layout distribution 320 of the variational autoencoder 314 onto a content-conditioned latent space N(μₛ, σₛ) or a conditional layout distribution 310 conditioned or modified by the set of fused features 306.

The layout generation system 102 thus learns the conditioning function 308 f(z, y) that takes a layout embedding 326 (z) sampled from N(μᵢ, σᵢ) and the fused feature vector (y) and outputs a new pair of μₛ, σₛ that describes a shared latent space for the input content and the layouts—e.g., the content-conditioned latent space N(μₛ, σₛ) or the conditional layout distribution 310. In some embodiments, the layout generation system 102 uses a multilayer perceptron to learn the conditioning function 308 (f).

As shown, the layout generation system 102 further trains or finetunes a conditional decoder 312 along with the encoder 316 of the variational autoencoder 314 (thus generating or training a disentangled variational autoencoder). For example, the layout generation system 102 uses the encoder 316 (E_{layout}) to induce or generate a content-conditioned layout distribution p̅(\hat{z}′|x,y) to map a layout sample x from real layout distribution p(x) to the feature space conditioned on y. Conversely, the conditional decoder 312 D_{c_layout} induces a distribution q̅(x″|z′) to map samples from a prior distribution q̅(z′) to the layout space that is implicitly conditioned on y (e.g., the conditional layout distribution 310). Accordingly, the layout generation system 102 learns a shared latent space from which to sample a content-conditioned layout embedding (z′) which, when decoded by the conditional decoder 312, produces a pixel level layout generation conditioned on the content conditions 302—e.g., the reconstructed content-conditioned design layout 328.

In one or more embodiments, the layout generation system 102 finetunes the encoder 316 and the conditional decoder 312 end-to-end by reducing or minimizing one or more measures of loss. For example, the layout generation system 102 determines a reconstruction loss and a maximum mean discrepancy (MMD) loss at multiple training iterations. The layout generation system 102 further modifies parameters of the encoder 316 and/or the conditional decoder 312 over the training iterations to reduce the measures of loss until satisfying respective loss thresholds. In some cases, the layout generation system 102 determines a reconstruction loss to compare the reconstructed content-conditioned design layout 328 with the sample design layout 322. For instance, the layout generation system 102 determines a reconstruction loss given by:

$${L}_{rec} = {‖ x - {D}_{conditioned\_layout} ( f ( {E}_{layout} ( x ) , y ) ) ‖}^{2}$$

where D_{conditioned_layout} represents the conditional decoder 312.

In some embodiments, the layout generation system 102 further determines an MMD loss to compare the conditional layout distribution 310 with a prior distribution (e.g., a standard normal distribution). For example, the layout generation system 102 determines an MMD loss given by:

$${L}_{MMD} = M M D ( \overline{p} ( {\hat{z}}^{′} \vert x , y ) \text{\vert \vert} \overline{q} ( {z}^{′} ) ) = M M D ( N ( {μ}_{s} , {σ}_{s} ) \text{\vert \vert} N ( 0 , 1 ) )$$

where q̅(z′) represents a prior distribution and p̅(\hat{z}′|x,y) represents the conditional layout distribution 310 (e.g., a learned joint distribution) of a conditioned latent space. Experimenters have demonstrated that using the MMD loss helps the content-conditioned variational generative model learn a better disentangled latent code while also preventing overfitting that is problematic in some prior systems. This is because, with an MMD-based variational autoencoder (e.g., the content-conditioned variational generative model), the layout generation system 102 is able to freely increase the weight of the regularization term (LMMD).

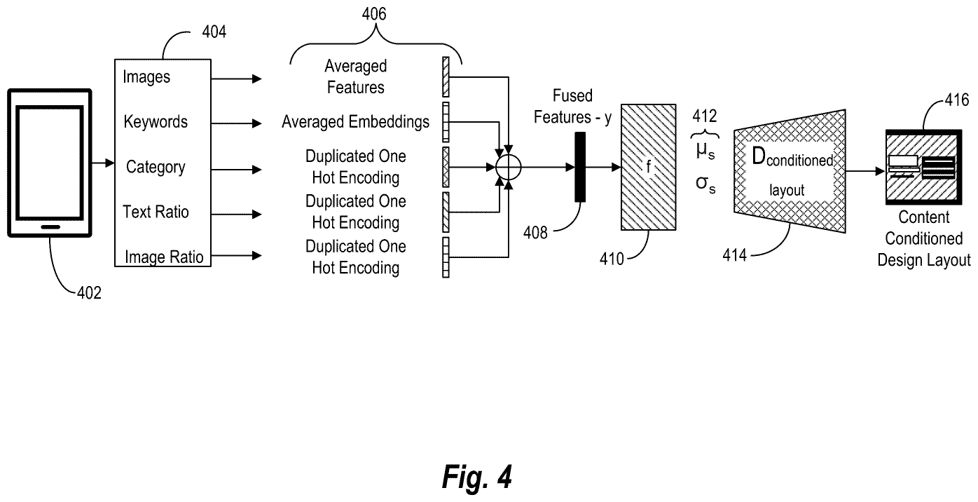

As mentioned above, in certain described embodiments, the layout generation system 102 generates a content-conditioned design layout from content conditions. In particular, the layout generation system 102 receives content conditions defining multimodal parameters for a design layout, and the layout generation system 102 uses a content-conditioned variational generative model (which includes a fusing function for fusing content condition embeddings, a conditional function, and a conditional decoder) to generate a content-conditioned design layout from the conditions. FIG. 4 illustrates an example diagram of implementing or utilizing a content-conditioned variational generative model to generate a design layout in accordance with one or more embodiments.

As illustrated in FIG. 4, the layout generation system 102 receives content conditions 404 from a client device 402. In particular, the layout generation system 102 receives the content conditions 404 via user interaction with the client device 402 to select and/or upload example images from which to extract content or placement parameters for image and/or text content. In addition, the layout generation system 102 receives keywords for content categories to include in a design and/or to define text to include within a graphical design.

The layout generation system 102 also receives an indication of a category that represents a dataset or type of content, such as fashion, food, news, science, travel, and wedding. In some cases, the layout generation system 102 can select from other or additional categories as well. The layout generation system 102 further receives an indication of (or otherwise determines) a text ratio from ground truth layout maps present in a dataset, indicating the ratio of the area covered by text pixels (defined by text boxes enclosing text content) to the total canvas area. In some cases, the layout generation system 102 quantizes the proportions uniformly with an interval of 0.1 to 7 scales (from 0.1 to 0.7). Further, the layout generation system 102 receives (or otherwise determines) an image ratio from the ground truth layout maps present in the datasets indicating the ratio of the area covered by the image pages to the total canvas area. In some cases, the layout generation system 102 quantizes the proportions uniformly with an interval of 0.1 to 10 scales (from 0.1 to 1).

As further illustrated in FIG. 4, the layout generation system 102 encodes or extracts content condition embeddings 406 from the content conditions 404. Indeed, as described above, the extracts content condition embeddings 406 as latent representations of the content conditions 404. The layout generation system 102 further generates a set of fused features 408 from the content condition embeddings 406 by combining or fusing (e.g., concatenating) the content condition embeddings 406. The layout generation system 102 further inputs the set of fused features 408 into a conditioning function 410 that generates or extracts a content-conditioned layout embedding from the set of fused features 408. Indeed, the layout generation system 102 generates the content-conditioned layout embedding within the conditional layout distribution 310 of a conditional latent space. To generate the content-conditioned layout embedding, the conditioning function 410 conditions a layout embedding distribution learned from a variational autoencoder (as described above) using the set of fused features 408. For instance, the layout generation system 102 samples a z from N(0, 1) and generates the fused feature vector y from the content conditions 404. The layout generation system 102 passes these two through the conditioning function 410 (a multilayer perceptron block) to generate a new latent code z′ (e.g., the content-conditioned layout embedding).

As also shown, the layout generation system 102 uses a conditional decoder 414 of the content-conditioned variational generative model to generate a content-conditioned design layout 416. More specifically, the conditional decoder 414 decodes the content-conditioned layout embedding (e.g., the latent code z′ from the conditional layout distribution 412) to generate the content-conditioned design layout 416 indicating locations and sizes for text content and image content according to the content conditions 404. Indeed, the layout generation system 102 applies a morphological image processing operation. For instances, the layout generation system 102 matches the design elements in order, first with respect to the aspect ratio and then the area of corresponding bounding boxes for images and text. As shown, the layout generation system 102 generates the content-conditioned design layout 416 with the solid dark portions representing vector graphics, the diagonally dashed portions representing natural image regions (e.g., humans, animals, or other scenes), and the solid white portions representing text regions.

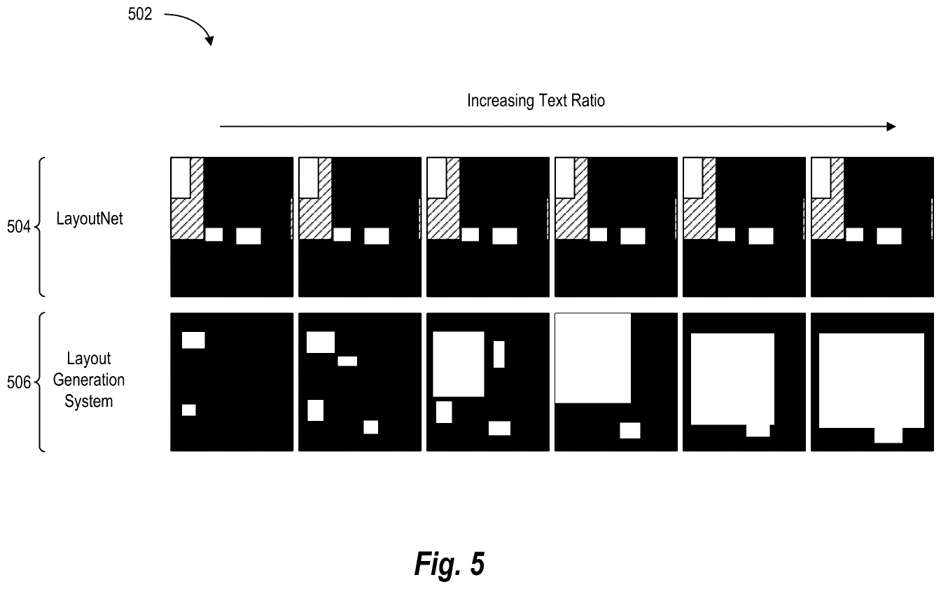

As noted above, in certain embodiments, the layout generation system 102 performs better than prior systems. Experimenters have demonstrated the improvements of the layout generation system 102 over certain previous state-of-the art systems. FIG. 5 illustrates an example table comparing qualitative results of the layout generation system 102 against a prior system in accordance with one or more embodiments.

As illustrated in FIG. 5, the table 502 includes perturbation results from increasing a text ratio. The row 504 depicts results generated by LayoutNet, as described by Xinru Zheng, Xiaotian Qiao, Ying Cao, and Rynson W. H. Lau in Content-Aware Generative Modeling of Graphic Design Layouts, ACM Transactions on Graphics, 38(4):1-15 (2019). As shown, LayoutNet generates design layouts that are identical or almost identical in response to increased text ratios. Indeed, LayoutNet does not adjust the size of text regions and thus generates inaccurate design layouts for increasing text ratios (where all other inputs are kept constant).

Conversely, as also illustrated in FIG. 5, the layout generation system 102 generates more accurate design layouts that increase text box sizes as the text ratio increase. Indeed, row 506 depicts design layouts generated by the layout generation system 102 for different text ratios. As the text ratios increase from left to right, the layout generation system 102 generates design layouts with increasing areas covered by text boxes (while keeping locations of the boxes in place). As shown, the solid dark regions indicate vector graphics while the solid white regions indicate text boxes. The layout generation system 102 thus generates more accurate design layouts, responsive to perturbations in text ratio.

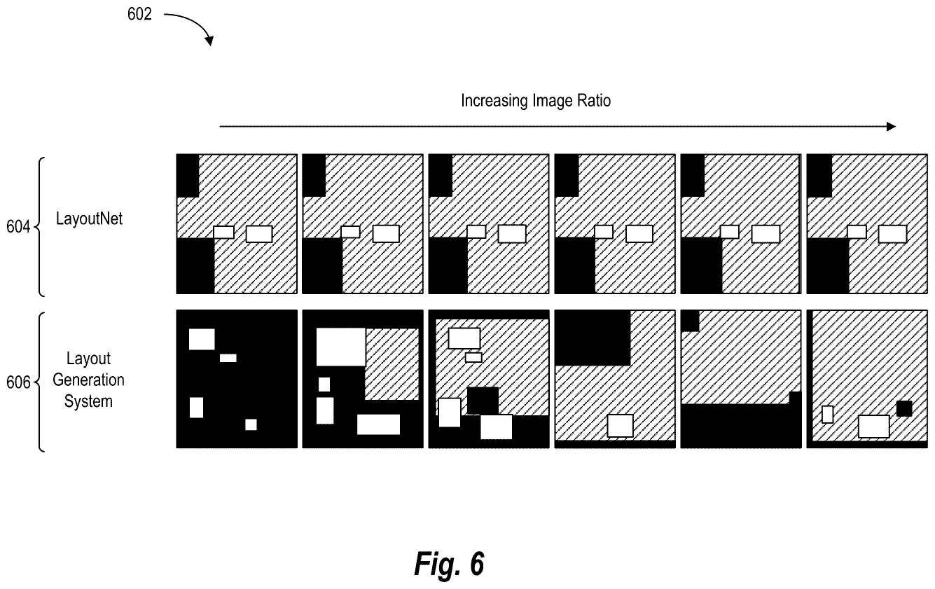

In addition to improving results for changes in text ratio, the layout generation system 102 also improves performance relating to changes in image ratio. In particular, the layout generation system 102 generates more accurate design layouts than prior systems when changing an image ratio condition. FIG. 6 illustrates an example table comparing qualitative results of the layout generation system 102 against a prior system in accordance with one or more embodiments.

As illustrated in FIG. 6, the table 602 includes perturbation results from increasing an image ratio. The row 604 depicts results generated by LayoutNet as image ratio increases from left to right. As shown, LayoutNet generates design layouts that are identical or nearly identical across the row 604. Indeed, LayoutNet generates inaccurate design layouts that do not adapt to differences in the image ratio.

Conversely, the row 606 depicts design layouts generated by the layout generation system 102. As shown, the layout generation system 102 adapts to different image ratios and generates design layouts that accurately reflect the increases in image ratio from left to right. As shown, the solid dark regions indicate vector graphics (e.g., backgrounds), the solid white regions indicate text boxes, and the dashed regions indicate natural images. As the image ratio increases, the natural image regions grow in area, as do the vector graphic regions in some cases, while the text boxes decrease in size and/or number. The layout generation system 102 thus generates design layouts that accurately reflect changes in image ratio.

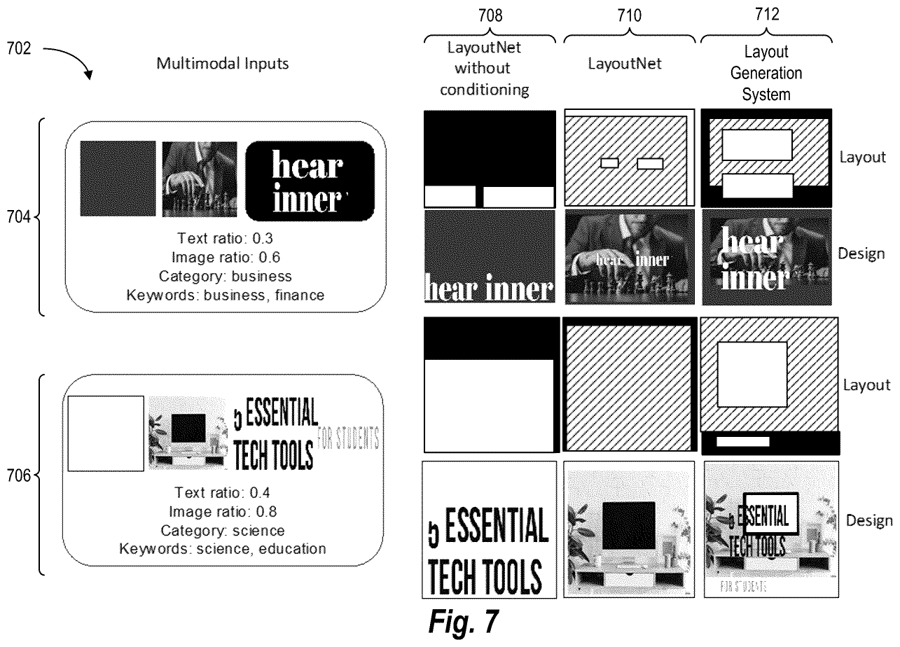

Experimenters have further demonstrated improvements of the layout generation system 102 compared to prior systems in generating graphics designs in end-to-end experiments. In particular, experimenters tested LayoutNet against the layout generation system 102 in generating design layouts from various sets of content conditions. FIG. 7 illustrates an example table comparing results of the layout generation system 102 with prior systems in accordance with one or more embodiments.

As illustrated in FIG. 7, the table 702 includes two rows, where each row corresponds to a different set of multimodal inputs or content conditions. As shown, the row 704 indicates content conditions including a set of images, a text ratio of 0.3, an image ratio of 0.6, a category of “business,” and keywords of “business” and “finance.” The table 702 also includes different columns, including the column 708 depicting results generated by LayoutNet without conditioning, the column 710 depicting results generated by LayoutNet within conditioning, and the column 712 depicting results generated by the layout generation system 102. As shown, the layout generation system 102 generates the most accurate design layouts and ultimate digital designs with text regions and image regions reflecting in design layouts reflecting the content conditions, and with image content and text content in digital designs reflecting the content conditions as well.

In addition, the row 706 illustrates another example set of content conditions, including a different set of images, a different text ratio of 0.4, an image ratio of 0.8, a category of “science,” and keywords of “science,” and “education.” Based on these content-conditions, the column 708 indicates the results of unconditioned LayoutNet while the column 710 depicts results from conditioned LayoutNet. As shown, the results in columns 708 and 710 reflect poor adaptation to content conditions and ultimately result in inaccurate and unappealing layouts and designs. Column 712, by contrast, depicts the results from the layout generation system 102 which conforms to the content conditions to generate a design layout and a resulting design with text and image content accurately placed and sized in a visually appealing manner.

As part of the experimental evaluations, the experimenters determined text ratios, image ratios, and intersection over union (IoU) to quantitatively determine results. For text ratios, experimenters determined the root mean squared error (RMSE) of the text ratios of a generated layout with the ground truth text ratio provided as input. For image ratios, experimenters determined the RMSE of image ratios in relation to ground truth image ratios provided as input. For IoU evaluation, experimenters determined the Jaccard index of generated layouts with their corresponding ground truth layouts and averaged over all generations. In addition, experimenters determined a layout Frechet inception distance (LFID) between fake and real layout distributions. Further, experimenters determined misalignment scores for overlap and misalignment loss. Through the experiments, the experimenters demonstrated that, over two datasets—1) Crello as described by Kota Yamaguchi in CanvasVAE: Learning to Generate Vector Graphic Documents, ICCV (2021) and 2) Magazine as described by Xingru Zheng et al. in Content-Aware Generative Modeling of Graphic Design Layouts, ACM Transactions on Graphics, 38(4):1-15 (2019) —the layout generation system 102 outperforms two previous state-of-the-art models on all of the aforementioned metrics. The two previous models are LayoutNet and LayoutDETR as described by Ning Yu et al. in LayoutDETR: Detection Transformer is a Good Multimodal Layout Designer, arXiv:2212.09877 (2022).

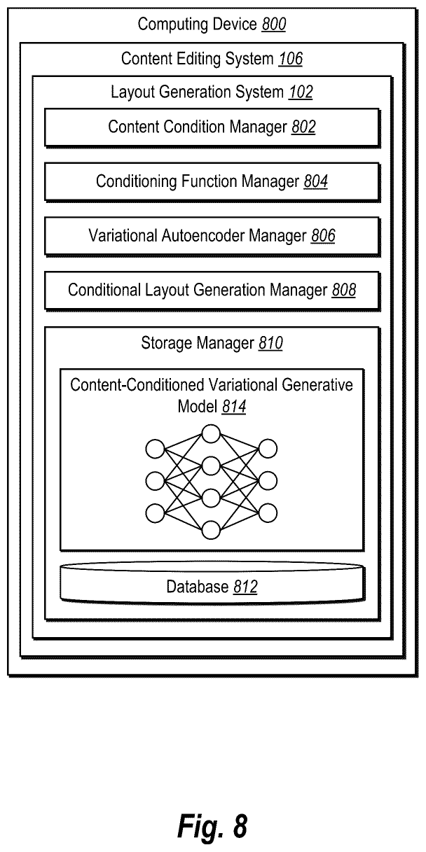

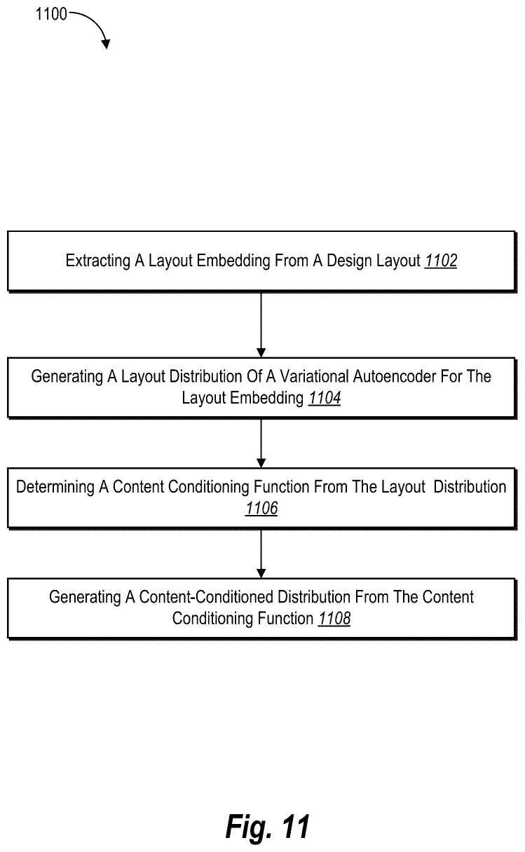

Looking now to FIG. 8, additional detail will be provided regarding components and capabilities of the layout generation system 102. Specifically, FIG. 11 illustrates an example schematic diagram of the layout generation system 102 on an example computing device 800 (e.g., one or more of the client device 108 and/or the server(s) 104). In some embodiments, the computing device 800 refers to a distributed computing system where different managers are located on different devices, as described above. As shown in FIG. 8, the layout generation system 102 includes a content condition manager 802, a conditioning function manager 804, a variational autoencoder manager 806, a conditional layout generation manager 808, and a storage manager 810.

As just mentioned, the layout generation system 102 includes a content condition manager 802. In particular, the content condition manager 802 manages, maintains, identifies, determines, or receives content conditions defining multimodal parameters for digital design layouts. For example, the content condition manager 802 receives content conditions from a client device. In addition, the content condition manager 802 generates a set of fused features from the content conditions. For instance, the content condition manager 802 encodes or extracts content embeddings from the content embeddings and fuses (e.g., concatenates) the content embeddings into a set of fused features.

As shown, the layout generation system 102 includes a conditioning function manager 804. In particular, the conditioning function manager 804 manages, conditions, modifies, generates, extracts, encodes, or determines a content-conditioned layout embedding. For example, the conditioning function manager 804 generates a content-conditioned layout embedding from a set of fused features and a layout embedding distribution. Indeed, the conditioning function manager 804 uses a conditioning function to generate a content-conditioned layout embedding by conditioning a layout embedding with a set of fused features as described herein. In some cases, the conditioning function manager 804 generates a conditioned layout distribution in a conditioned latent space from a non-conditioned layout distribution in a non-conditioned latent space.

As also shown, the layout generation system 102 includes a variational autoencoder manager 806. In particular, the variational autoencoder manager 806 manages, generates, trains, determines, utilizes, or implements a variational autoencoder. For example, the variational autoencoder manager 806 trains a variational autoencoder using a training database of sample content conditions and sample design layouts. In some cases, the variational autoencoder manager 806 trains an encoder, a decoder, and a conditional decoder using one or more loss functions, including a first reconstruction loss function for the encoder-decoder training, a second reconstruction loss function for the encoder-conditional-decoder training, a KL divergence loss function, and an MMD loss function, as described herein.

As further shown in FIG. 8, the layout generation system 102 includes a conditional layout generation manager 808. In particular, the conditional layout generation manager 808 generates, conditions, modifies, decodes, or determines a content-conditioned design layout. For example, the conditional layout generation manager 808 generates a content-conditioned design layout (and/or a digital design using the layout) from a content-conditioned layout embedding. In some cases, the conditional layout generation manager 808 uses a (conditional decoder of a) trained content-conditioned variational generative model to generate the content-conditioned design layout.

The layout generation system 102 further includes a storage manager 810. The storage manager 810 operates in conjunction with, or includes, one or more memory devices such as the database 812 (e.g., the database 114) that store various data such as training data including sample design layouts and sample content conditions. As shown, the database 812 stores a content-conditioned variational generative model 814 accessible and usable by other components of the layout generation system 102. In some cases, the content-conditioned variational generative model 814 includes an encoder, a decoder, and conditional decoder, as described herein. In certain embodiments, the content-conditioned variational generative model 814 also includes a fusion function and a conditioning function. The storage manager 810 communicates with the other components of the layout generation system 102 to facilitate the operations and functions described herein.

In one or more embodiments, each of the components of the layout generation system 102 are in communication with one another using any suitable communication technologies. Additionally, the components of the layout generation system 102 is in communication with one or more other devices including one or more client devices described above. It will be recognized that although the components of the layout generation system 102 are shown to be separate in FIG. 8, any of the subcomponents may be combined into fewer components, such as into a single component, or divided into more components as may serve a particular implementation. Furthermore, although the components of FIG. 8 are described in connection with the layout generation system 102, at least some of the components for performing operations in conjunction with the layout generation system 102 described herein may be implemented on other devices within the environment.

The components of the layout generation system 102, in one or more implementations, includes software, hardware, or both. For example, the components of the layout generation system 102 include one or more instructions stored on a computer-readable storage medium and executable by processors of one or more computing devices (e.g., the computing device 800). When executed by the one or more processors, the computer-executable instructions of the layout generation system 102 cause the computing device 800 to perform the methods described herein. Alternatively, the components of the layout generation system 102 comprises hardware, such as a special purpose processing device to perform a certain function or group of functions. Additionally, or alternatively, the components of the layout generation system 102 includes a combination of computer-executable instructions and hardware.

Furthermore, the components of the layout generation system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the layout generation system 102 may be implemented as part of a stand-alone application on a personal computing device or a mobile device. Alternatively, or additionally, the components of the layout generation system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

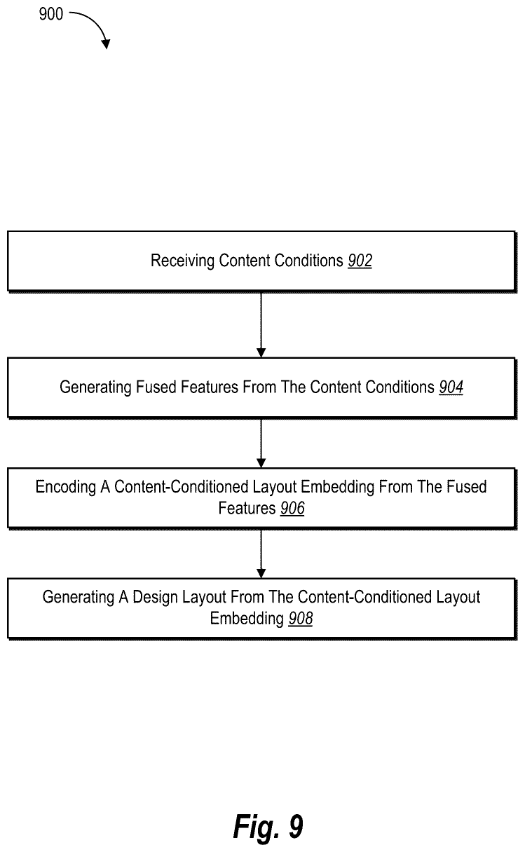

FIGS. 1-8 the corresponding text, and the examples provide a number of different systems, methods, and non-transitory computer readable media for training and utilizing a content-conditioned variational generative model to generate content-conditioned design layouts from content conditions defining multimodal layout parameters. In addition to the foregoing, embodiments are describable in terms of flowcharts comprising acts for accomplishing a particular result. For example, FIGS. 9-11 illustrate flowcharts of example sequences or series of acts in accordance with one or more embodiments.

While FIGS. 9-11 illustrate acts according to particular embodiments, alternative embodiments may omit, add to, reorder, and/or modify any of the acts shown in FIGS. 9-11. The acts of FIGS. 9-11 are sometimes performed as part of a method. Alternatively, a non-transitory computer readable medium comprises instructions, that when executed by one or more processors, cause a computing device to perform the acts of FIGS. 9-11. In still further embodiments, a system performs the acts of FIGS. 9-11. Additionally, the acts described herein may be repeated or performed in parallel with one another or in parallel with different instances of the same or other similar acts.

FIG. 9 illustrates an example series of acts 900 for generating a design layout using content-conditions. In particular, the series of acts 900 includes an act 902 of receiving content conditions. For example, the act 902 involves receiving, from a client device, one or more content conditions defining parameters for generating design layouts. The series of acts 900 also includes an act 904 of generating fused features from the content conditions. For example, the act 904 involves generating a set of fused features from the one or more content conditions. In addition, the series of acts 900 includes an act 906 of encoding a content-conditioned layout embedding from the fused features. For example, the act 906 involves encoding, utilizing a machine learning model (e.g., a content-conditioned variational generative model), a content-conditioned layout embedding from the set of fused features. Additionally, the series of acts 900 includes an act 908 of generating a design layout from the content-conditioned layout embedding. For example, the act 908 involves generating, from the content-conditioned layout embedding utilizing the machine learning model, a design layout comprising multimodal layout parameters defined by the one or more content conditions.

In some embodiments, the series of acts 900 includes an act of generating the set of fused features by: extracting content condition embeddings from the one or more content conditions and combining the content condition embeddings into the set of fused features. In addition, the series of acts 900 includes an act of encoding the content-conditioned layout embedding by utilizing a content conditioning function within the machine learning model to combine the set of fused features with a layout embedding distribution. Further, the series of acts 900 includes generating the design layout by utilizing a conditioned decoder of the machine learning model to decode the content-conditioned layout embedding.

In addition, the series of acts 900 includes an act of generating the content-conditioned layout embedding by: utilizing a variational autoencoder to generate a layout embedding distribution and projecting the layout embedding distribution onto a content-conditioned layout distribution conditioned by the set of fused features. The series of acts 900 further includes an act of receiving the one or more content conditions comprises receiving one or more of images, keywords, a category, a text ratio, or an image ratio defining the parameters for generating design layouts. In some embodiments, the series of acts 900 includes an act of generating the design layout by generating the design layout reflecting one or more of visual elements of the images, visual elements defined by the keywords, a ratio of text space to design space defined by the text ratio, or a ratio of image space to design space defined by the image ratio.

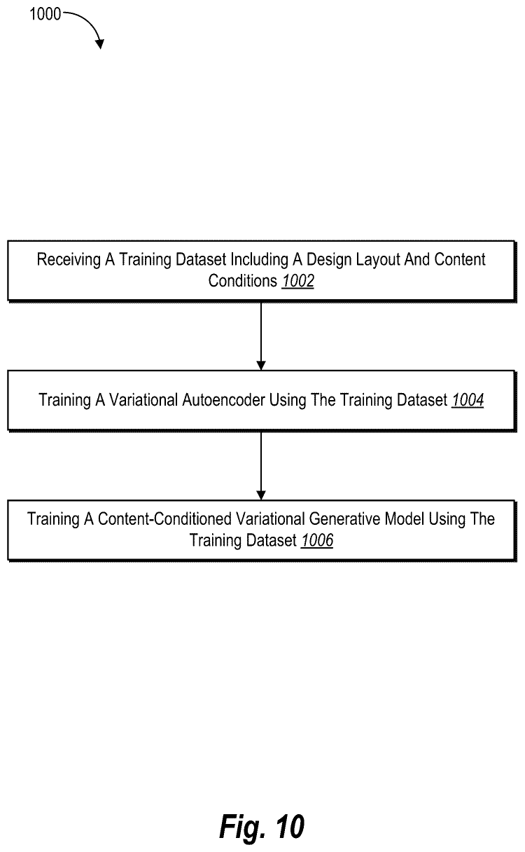

FIG. 10 illustrates an example series of acts 1000 for training a content-conditioned variational generative model using a training dataset. As shown, the series of acts 1000 includes an act 1002 of receiving a training dataset including a design layout and content conditions. In particular, the act 1002 involves receiving a training dataset comprising a design layout and one or more content conditions defining design layout parameters. In addition, the series of acts 1000 includes an act 1004 of training a variational autoencoder using the training dataset. For example, the act 1004 involves training a variational autoencoder using the training dataset to generate a trained variational autoencoder that generates a reconstructed design layout from the design layout. Further, the series of acts 1000 includes an act 1006 of training content-conditioned variational generative model using the training dataset. In some cases, the act 1006 involves training a content-conditioned variational generative model using the training dataset by comparing, with the design layout, a content-conditioned reconstructed design layout generated from the one or more content conditions.

In some embodiments, the series of acts 1000 includes an act of learning, as part of the content-conditioned variational generative model, a content conditioning function that projects a layout embedding distribution onto a content-conditioned layout distribution comprising a shared latent space for the layout embedding distribution and the one or more content conditions. In addition, the series of acts 1000 includes an act of generating a set of fused features from the one or more content conditions by combining content condition embeddings extracted from the one or more content conditions. Further, the series of acts 1000 includes an act of training the content-conditioned variational generative model by training a conditioned decoder as part of the content-conditioned variational generative model to decode content-conditioned layout embeddings.

In one or more embodiments, the series of acts 1000 includes an act of training the variational autoencoder comprises using the training dataset to train, as part of the variational autoencoder, an encoder that generates a layout distribution from the design layout in a layout space. Additionally, the series of acts 1000 includes an act of training the content-conditioned variational generative model by modifying parameters of a conditioned decoder as part of the content-conditioned variational generative model based on comparing the content-conditioned reconstructed design layout with the design layout.

In some embodiments, the series of act 1000 includes an act of training the variational autoencoder by: extracting, using an encoder of the variational autoencoder, a layout embedding from the design layout within a layout embedding distribution, generating, using a decoder of the variational autoencoder, a reconstructed design layout from the layout embedding, comparing the reconstructed design layout with the design layout, and comparing the layout embedding distribution with a prior distribution.

FIG. 11 illustrates an example series of acts 1100 for training and/or implementing a content-conditioned variational generative model to generate a design layout. In particular, the series of acts 1100 includes an act 1102 of extracting a layout embedding from a design layout. For example, the act 1102 involves extracting, from a design layout utilizing a variational autoencoder, a layout embedding representing the design layout in a latent space. In addition, the series of acts 1100 includes an act 1104 of generating a layout distribution of a variational autoencoder for the layout embedding. For example, the act 1104 involves generating a layout distribution of the latent space for the variational autoencoder by comparing a reconstructed design layout generated from the layout embedding with the design layout. The series of acts 1100 also includes an act 1106 of determining a content conditioning function from the layout distribution. For example, the act 1106 involves determining, from the layout distribution utilizing a content-conditioned variational generative model, a content conditioning function that modifies design layouts according to content conditions defining parameters for design layouts. Further, the series of acts 1100 includes an act 1108 of generating a content-conditioned distribution from the content conditioning function. For example, the act 1108 involves generating, from the content conditioning function utilizing the content-conditioned variational generative model, a content-conditioned distribution by comparing a content-conditioned reconstructed design layout with the design layout.

In some embodiments, the series of acts 1100 includes an act of comparing the content-conditioned distribution with a prior distribution. Additionally, the series of acts 1100 includes an act of modifying parameters of the content-conditioned variational generative model based on comparing the content-conditioned distribution with the prior distribution. In some cases, the series of acts 1100 includes an act of generating the reconstructed design layout by using the variational autoencoder to decode the layout embedding from the latent space.

In one or more embodiments, the series of acts 1100 includes an act of using a discrepancy loss to modify parameters of the content-conditioned variational generative model based on comparing the content-conditioned distribution with a prior distribution. In addition, the series of acts 1100 includes an act of encoding a content-conditioned layout embedding by using the content conditioning function that combines the design layout with the content conditions. Further, the series of acts 1100 includes an act of generating the content-conditioned reconstructed design layout by using the content-conditioned variational generative model to decode the content-conditioned layout embedding. In certain embodiments, the series of acts 1100 includes an act of extracting the layout embedding by using the variational autoencoder as part of the content-conditioned variational generative model to encode the design layout into the latent space.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., computing device 800, server(s) 104, and/or client device 108). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, one or more content conditions defining parameters for generating design layouts;
generating a set of fused features from the one or more content conditions;
encoding, utilizing a machine learning model, a content-conditioned layout embedding from the set of fused features; and
generating, from the content-conditioned layout embedding utilizing the machine learning model, a design layout comprising multimodal layout parameters defined by the one or more content conditions.

2. The method of claim 1, wherein generating the set of fused features comprises:
extracting content condition embeddings from the one or more content conditions; and
combining the content condition embeddings into the set of fused features.

3. The method of claim 1, wherein encoding the content-conditioned layout embedding comprises utilizing a content conditioning function within the machine learning model to combine the set of fused features with a layout embedding distribution.

4. The method of claim 1, wherein generating the design layout comprises utilizing a conditioned decoder of the machine learning model to decode the content-conditioned layout embedding.

5. The method of claim 1, wherein generating the content-conditioned layout embedding comprises:
utilizing a variational autoencoder to generate a layout embedding distribution; and
projecting the layout embedding distribution onto a content-conditioned layout distribution conditioned by the set of fused features.

6. The method of claim 1, wherein receiving the one or more content conditions comprises receiving one or more of images, keywords, a category, a text ratio, or an image ratio defining the parameters for generating design layouts.

7. The method of claim 6, wherein generating the design layout comprises generating the design layout reflecting one or more of visual elements of the images, visual elements defined by the keywords, a ratio of text space to design space defined by the text ratio, or a ratio of image space to design space defined by the image ratio.

8. A method comprising:
receiving a training dataset comprising a design layout and one or more content conditions defining design layout parameters;
training a variational autoencoder using the training dataset to generate a trained variational autoencoder that projects a layout embedding distribution for generating a reconstructed design layout from the design layout; and
training a content-conditioned variational generative model using the training dataset by comparing, with the design layout, a content-conditioned reconstructed design layout generated from the layout embedding distribution and the one or more content conditions.

9. The method of claim 8, further comprising learning, as part of the content-conditioned variational generative model, a content conditioning function that projects the layout embedding distribution onto a content-conditioned layout distribution comprising a shared latent space for the layout embedding distribution and the one or more content conditions.

10. The method of claim 8, further comprising generating a set of fused features from the one or more content conditions by combining content condition embeddings extracted from the one or more content conditions.

11. The method of claim 10, wherein training the content-conditioned variational generative model comprises training a conditioned decoder as part of the content-conditioned variational generative model to decode content-conditioned layout embeddings.

12. The method of claim 8, wherein training the variational autoencoder comprises using the training dataset to train, as part of the variational autoencoder, an encoder that generates a layout distribution from the design layout in a layout space.

13. The method of claim 8, wherein training the content-conditioned variational generative model comprises modifying parameters of a conditioned decoder as part of the content-conditioned variational generative model based on comparing the content-conditioned reconstructed design layout with the design layout.

14. The method of claim 8, wherein training the variational autoencoder comprises:
extracting, using an encoder of the variational autoencoder, a layout embedding from the design layout within a layout embedding distribution;
generating, using a decoder of the variational autoencoder, a reconstructed design layout from the layout embedding;
comparing the reconstructed design layout with the design layout; and
comparing the layout embedding distribution with a prior distribution.

15. A non-transitory computer readable medium storing instructions which, when executed by a processing device, cause the processing device to perform operations comprising:
receiving, from a client device, one or more content conditions defining parameters for generating design layouts;
generating a set of fused features from the one or more content conditions;
encoding, utilizing a machine learning model, a content-conditioned layout embedding from the set of fused features; and
generating, from the content-conditioned layout embedding utilizing the machine learning model, a design layout comprising multimodal layout parameters defined by the one or more content conditions.

16. The non-transitory computer readable medium of claim 15, wherein the operations further comprise:
extracting, from the design layout utilizing a variational autoencoder, a layout embedding representing the design layout in a latent space; and
generating a layout distribution of the latent space for the variational autoencoder by comparing a reconstructed design layout generated from the layout embedding with the design layout.

17. The non-transitory computer readable medium of claim 16, wherein the operations further comprise:
determining, from the layout distribution utilizing the machine learning model, a content conditioning function that modifies design layouts according to content conditions defining parameters for design layouts; and
generating, from the content conditioning function utilizing the machine learning model, a content-conditioned distribution by comparing a content-conditioned reconstructed design layout with the design layout.

18. The non-transitory computer readable medium of claim 17, wherein the operations further comprise using a discrepancy loss to modify parameters of the machine learning model based on comparing the content-conditioned distribution with a prior distribution.

19. The non-transitory computer readable medium of claim 15, wherein the operations further comprise:
encoding a content-conditioned layout embedding by using a content conditioning function that combines an initial design layout with the one or more content conditions; and
generating the design layout by using the machine learning model to decode the content-conditioned layout embedding.

20. The non-transitory computer readable medium of claim 15, wherein the operations further comprise:
extracting content condition embeddings from the one or more content conditions; and
combining the content condition embeddings into the set of fused features.
